(19) United States
(12) Patent Application Publication
(10) Pub. No.: US 2013/0080527 A1
(43) Pub. Date: Mar. 28, 2013

(54) Online Dating Pool Sorting via Standardized Profile

(71) Applicants: Troy Thomas Pummill, Soquel, CA (US); Terry Hardie, Union City, CA (US)

(72) Inventors: Troy Thomas Pummill, Soquel, CA (US); Terry Hardie, Union City, CA (US)

(21) Appl. No.: 13/605,976

(22) Filed: Sep. 6, 2012

Related U.S. Application Data
(60) Provisional application No. 61/538,193, filed on Sep. 23, 2011.

(51) Int. Cl. G06F 15/16

(52) U.S. Cl. 709/204

(57) ABSTRACT

A method for sorting online dating subscribers into separate pools using a set of standardized personality or trait profiles.

### CROSS-REFERENCE TO RELATED APPLICATION

The present application claims priority to U.S. Provisional Application No. 61/538,193, filed on Sep. 23, 2011, which is incorporated herein by reference.

### BACKGROUND OF THE INVENTION

Much as the way world wide web has revolutionized how we search and obtain information, (Internet) Online Dating has changed the way in which we date and seek love. Online dating sites permit a subscriber to search for other subscribers on that Internet dating site using various methodologies specific to that particular online dating site. When a subscriber identifies another subscriber that is a potential match, the first subscriber will initiate communication to the other subscriber and through the course of the communication they will decide whether to go on a first date.

To aid subscribers in finding potential matches, Internet dating sites tend to employ an algorithm or tools to help their subscribers identify good potential (relationship) matches.

Some Internet dating sites employ a matching algorithm that is fueled by a (sometimes lengthy) questionnaire about the personality traits, and possibly even physical traits. (Physical traits may indicate something about the DNA composition of the person, for example, people whose middle finger is much longer than the first finger may, according to DNA profiling, have more testosterone there be more inclined to risk-taking). Before a potential subscriber can use the online dating site, he must answer this questionnaire. The questionnaire permits the potential subscriber taking the test to be categorized and placed into a pool of online dating subscribers who are similarly categorized (those who bear similar traits). The persons within a particular pool are potential relationship matches.

Others Internet dating sites employ a combination of user supplied matching elements (e.g. distance, number of children, interests, income) coupled with a personal essay written by the subscriber. When the potential online dater subscribes to the dating site, he must set his matching elements and create a personal essay. The essay, known as a profile, contains whatever information the subscriber believes will help the reader (other subscribers) in determining if there is a (relationship) match.

The problem is that neither of the current methods are very successful in helping subscribers find their matches.

With the questionnaire style algorithm, the subscriber generally must answer an enormous number of questions in order for the sorting algorithm to place the subscriber into a categorized dating pool. The sheer number of questions is a significant barrier to the would-be subscriber.

The user provided profile system relies on the ability of the subscriber to provide a written description (essay, profile) that aids other subscribers in determining if there might be a potential match. As most people don't know what to write, or how to write, these descriptions are generally very generic and, for some reason, all end up being nearly universally identical. As the profile is the primary tool/criteria for matching in these types of online dating sites, the ability for subscribers to properly sort and filter the subscriber database (pool) for matches is destroyed as all of the profiles tend to be nearly identical.

Due to these failures and obstacles, it is well-known that Online Dating sites fail to deliver matches to the vast majority of its customers. Millions of subscribers spend nearly $1 B annually on online dating without achieving their goal.

The object of the present invention is to create a system wherein both of these major online dating pitfalls are remedied. The object is to employ a set of standardized profiles, each representing a distinct personality type. When subscribers sign up for service, they will read the standard profiles and select the one that describes them the best. From this selection, they will be placed into a group (pool) of subscribers who also selected that particular profile. All the subscribers in a particular pool are then matches.

This removes the barriers of subscribers having to answer numerous questions or write their own profiles and pre-sorts alike users (those with similar traits) into the same pool.

### BRIEF SUMMARY OF THE INVENTION

A method for sorting online daters in to (subscriber) pools is disclosed. By examining and researching personality and relationship traits, it is possible to derive and distill a set of characteristics for each type of person. For each type of person, the corresponding characteristics are written out as a list of statements, or an essay, to create an online dating profile. As there is only one profile for each type of person (personality), the profiles become the standard for that type of personality/person.

When an online dating user subscribes to a service, the user will read the standardized profile. After reading the standardized profiles, the user selects the one profile that most represents their personal characteristics.

The selection of a particular standardized profile places a person into a subscriber pool with others who selected that same profile. Subscribers in the same pools are potential matches due to the selecting the same profile (as the one that most described them).

Pre-sorting users into pools using standardized profiles results in ease of matching as everyone in any given pool shares similar characteristics and is, therefore, similarly matched. Using standardized profiles eliminates the need for an extensive questionnaire or for users to write their own extensive profile.

### DETAILED DESCRIPTION OF THE INVENTION

Given particular personality types, it is possible to describe each of those personality types via a list of individual statements, for example:

The feeler personality type:

a. I tend to think more than feel
b. I cry easily

The thinker personality type:

a. I tend to feel more than think
b. I am not easily moved

Grouping personality trait statements together creates an overall document that describes a person and their traits. In online dating parlance, a group of statements that describe a person is known as profile.

By creating a standardized profile for each personality type (like the feeler profile and the thinker profile), it is possible then to post the standard profiles on a dating web site. The potential subscribers can then visit the website and read the profiles.

When a user recognizes their overall traits in a profile, they select that particular profile and are the placed into a pool of subscribers who also selected that profile based upon the listed traits. (the feeler type of person will read the standard profiles and recognize their personality traits in the feeler profile. They will then select the feeler profile and be placed into the feeler dating pool)

Users segmented into pools by selecting the profiles can then easily find matches within their selected pool based upon their shared, common traits.

As an adjunct, it is possible for a user to create or amend a standardized profile by selecting from a list of trait statements. When the list is completed, the user is placed into a pool of users with similarly created or amended profiles.

While the present invention has been described in terms of specific embodiments, it should be apparent to those skilled in the art that the scope of the present invention is not limited to these specific embodiments. The specification and drawings are, accordingly, to be regarded in illustrative rather than a restrictive sense. Persons of ordinary skill in the area will recognize that additions, subtractions, substitutions, and other modifications may be made without departing from the broader spirit and scope of the invention as set forth in the claims.

What is claimed is:

1. A method of using standardized profiles (essays or group of statements) to gather people with similar personalities or traits into groups for the purposes of internet-based (online) dating.

2. A method of claim 1 wherein the subscriber amends a standardized profile by selecting or deleting portions of the standardized profile(s).

3. A method of claim 1 wherein the subscriber creates a standardized profile by selecting from a list of statements
